(19) United States
(12) Patent Application Publication
(10) Pub. No.: US 2008/0060383 A1
(43) Pub. Date: Mar. 13, 2008

(54) Method for Examining the Presence of Nickle Sulphide Inclusions in Tempered Safety Glass and Method Therefor

(75) Inventor: Thomas Schuller, Weyer (AT)

Correspondence Address: GREENBLUM & BERNSTEIN, P.L.C., 1950 ROLAND CLARKE PLACE, RESTON, VA, 20191, US

(73) Assignee: GLASSIQ GMBH & CO. KG, Barleben (DE)

(21) Appl. No.: 11/813,719

(22) PCT Filed: Jan. 10, 2006
(86) PCT No.: PCT/AT06/00009

§ 371 Date: Nov. 26, 2007

(30) Foreign Application Priority Data
Jan. 12, 2005 (AT) A 39/2005

(51) Int. Cl. G01N 25/72

(52) U.S. Cl. 65/29.18

(57) ABSTRACT

The invention relates to a method for testing for the presence of nickel sulfide inclusions in an object made of glass. In order to be able to perform this in an energy-saving and rapid manner, according to the invention a method is proposed for testing for the presence of nickel sulfide inclusions in an object made of glass, such as a tempered safety glass, during a tempering or hardening thereof, the object being brought to a temperature of at least 500° C. and at this temperature an electromagnetic radiation emitted from the object being recorded and evaluated, after which the object is intensely cooled in order to temper or harden it. The invention further comprises a device for testing for the presence of nickel sulfide inclusions in an object made of glass, such as a tempered safety glass.

The invention relates to a method for testing for the presence of nickel sulfide inclusions in an object made of glass, such as a tempered safety glass.

The invention further relates to a device for testing for the presence of nickel sulfide inclusions in an object made of glass, such as a tempered safety glass.

Large-area glass panes, such as those used in building construction, for example, are subjected to a thermal treatment to temper or harden them for intended uses. The aim of tempering or hardening glass panes is to apply compressive prestress so that fissures present on the surface of a glass pane are pressed together, thereby increasing the failure-free service life of the glass pane.

Tempering or hardening processes are of particular importance for tempered safety glass. Such glass is used for facade glazing, for example, and must meet extremely demanding requirements not only for a desired fracture pattern but also with regard to a long service life or non-occurrence of material failure.

However, a long service life or high material stability is not guaranteed by tempering or hardening alone by any means, since during manufacture it is possible not only for fissures to occur in a glass, but also for foreign materials to be enclosed therein, which can be the cause of material failure.

Specifically in conjunction with glass panes, and in particular tempered safety glass, nickel sulfide inclusions are particularly unpleasant inclusions. Without special measures of a chemical nature, during a manufacture of glass panes through reduction of sodium sulfate, introduced via starting materials, and from nickel, which dissolves from the stainless steel of a production device, nickel sulfide compounds (for example, NiS and/or Ni₇S₆ inclusions, NiSₓ inclusions in which x=1.0 to 1.1 being fracture-critical) can be formed, resulting in nickel sulfide inclusions in finished glass objects. If a glass object containing nickel sulfide inclusions is then tempered or hardened, i.e., brought to elevated temperatures greater than 500° C., and subsequently intensely cooled, for example by blowing with cold air, at the elevated temperatures NiS converts to an allotropic high-temperature modification (α-NiS) which is stable above 379° C. Under intense cooling to approximately room temperature, this high-temperature modification becomes “frozen,” and over a period of months and years at room temperature slowly converts to the β-NiS modification which is thermodynamically stable at room or ambient, temperature, and which has a volume that is approximately 3 volume percent greater than the α-NiS modification. As a result of the volume increase, for a corresponding size and position of the inclusions stresses may occur inside tempered safety glass, for example, of sufficient magnitude that a spontaneous fracture or unpredictable material failure may occur years later.

It is understood that spontaneous fractures of glass used in the construction industry or in motor vehicles represent a great hazard potential and may result in significant personal injury and property damage.

Efforts to reduce this hazard potential during use by means of prior testing are known from the prior art. Thus, it is known from EP 0 853 069 B1 to subject tempered safety glass, after tempering or hardening for several hours, to a further heat treatment at a temperature of up to 300° C. At these temperatures a conversion of α-NiS to β-NiS is more rapid than at room or ambient temperature, for which reason glass panes with large nickel sulfide inclusions and a correspondingly high probability of spontaneous fracture during subsequent use cannot withstand this heat treatment or this test with a given probability, and thus may be rejected.

The so-called heat soak test described above is energy-intensive and lengthy. Proceeding from this prior art, the object of the invention is to provide a method of the type mentioned at the outset which is less energy-intensive and which may be performed more quickly. A further object of the invention is to provide a device for testing for the presence of nickel sulfide inclusions in an object made of glass, by means of which inclusions composed of nickel sulfide may be quickly detected in an energy-efficient manner.

The object of the invention relating to the method is achieved by a method according to claim 1. Advantageous variants of a method according to the invention are the subject matter of claims 2 through 6.

One particular advantage of a method according to the invention is that testing for the presence of nickel sulfide inclusions takes place within the scope of tempering or hardening. At the end of the tempering/hardening, information is already available concerning possible nickel sulfide inclusions, and further heat treatments as a quality test are not necessary. A method according to the invention may therefore be carried out quickly and in an energy-saving manner.

According to the invention, use is made of the knowledge that at temperatures greater than 500° C. nickel sulfide inclusions in glass emit a characteristic radiation intensively, whereas an object made of glass such as tempered safety glass emits no radiation or radiation of very low intensity. Thus, in regions in tempered safety glass, for example, in which no nickel sulfide inclusions are present, only very weak radiation is observed, whereas in regions containing nickel sulfide inclusions, intense emissions may be recorded.

The invention also has in particular the advantage that, as a result of their characteristic emission spectrum, nickel sulfide inclusions can be directly or immediately detected. This allows, for example, the size of the inclusions, the location of the inclusions in the glass and the relative frequency of the inclusions as well as the spacing or arrangement of individual inclusions to be determined. Since only a few emitted photons are sufficient for recording, nickel sulfide inclusions can be detected in the submicrometer range by use of a method according to the invention. This allows quantitative criteria to be established for the use or non-use of tempered glass objects.

In one particularly advantageous variant of the invention, the object is brought to a temperature of at least 600° C. Based on these temperatures, on the one hand a good tempering or a good hardening is achieved, and fissures in the glass object are completely avoided as far as possible. On the other hand, at increasing temperature the intensity of emission from nickel sulfide inclusions increases, and at a temperature above 600° C. nickel sulfide inclusions can be detected with still greater reliability. To achieve these effects and to thereby operate with the greatest possible energy savings, it is advantageous when the object is brought to a temperature of 630 to 680° C.

Radiation emitted from nickel sulfide inclusions is advantageously recorded and evaluated in a wavelength range of 800 to 1200 nm. In this wavelength range, emissions from a glass matrix are low, so that in the recording of radiation a ratio of emissions from nickel sulfide inclusions to emissions from the glass matrix is high, and during evaluation nickel sulfide inclusions are particularly prominent relative to the glass matrix.

Emitted radiation is preferably recorded using a CCD camera or a CMOS camera. A charge coupled device (CCD) camera as well as a complementary metal oxide semiconductor (CMOS) camera basically allow emitted radiation to be recorded within fractions of a second, so that emissions can be detected and evaluated extremely quickly relative to the tempering or hardening process, which lasts at least several minutes. Recorded radiation is preferably evaluated by means of a computer. In particular when one of the above-referenced cameras is used, testing for the presence of nickel sulfide inclusions may be quickly performed in a completely automated manner.

In one variant of the invention, it is provided for the object while in motion to be brought to a temperature of at least 500° C. in a continuous furnace, for example, and after the temperature is reached the emitted radiation to be recorded by regions while the object continues to move. In this manner a glass object, in particular tempered safety glass, may be tempered and tested for the presence of nickel sulfide inclusions particularly quickly.

The further object of the invention, to provide a device for testing for the presence of nickel sulfide inclusions in an object made of glass, by means of which inclusions of nickel sulfide may be quickly detected in an energy-efficient manner, is achieved by a device according to claim 7. Advantageous further developments of a device according to the invention are the subject matter of claims 8 through 12.

With a device according to the invention, testing for the presence of nickel sulfide inclusions in glass objects can be carried out in a simple and energy-saving manner. A suitably designed darkroom is used for recording an object made of glass, heated within the scope of a tempering or hardening process to a temperature of at least 500° C., in a dark chamber with the exclusion of radiation foreign to the object. By means of a device connected to the darkroom, emissions from nickel sulfide inclusions which in a manner of speaking shine out from a low-emission glass matrix may be recorded.

Another advantage of a device according to the invention is the possibility of directly or immediately observing nickel sulfide inclusions, which increases the reliability of predictions of possible future spontaneous damage to a tempered object made of glass, in particular a tempered safety glass.

Since radiation emitted from nickel sulfide inclusions can be recorded per se within a short time, testing for the presence of nickel sulfide inclusions can be performed extremely quickly with a device according to the invention.

In one advantageous further development of the invention, the darkroom may be cooled. In this case the darkroom may be kept at a constant temperature, even when objects heated to several hundred degrees Celsius are being recorded, thereby ensuring constant conditions for recording emitted radiation and avoiding thermally induced interference signals.

When the device includes a CCD camera or a CMOS camera, emitted radiation can be quickly recorded within fractions of a second, and a glass object to be tested needs to be kept at a hardening temperature only for this period of time.

Rapid measurement is particularly advantageous in cases where it may be necessary to conduct testing only in certain regions, for example for large-area glass panes. In particular for such applications, for a device according to the invention it is advantageous for the CCD camera or CMOS camera to be connected to a computer to render possible rapid and automated testing.

The darkroom may be coated internally with a black high-temperature paint, which is advantageous with regard to recording very weak emissions, for example when very small nickel sulfide inclusions are present. To achieve a rough coating and thus avoid unintentional reflections in the darkroom, it is advantageous for this coating to be produced by spraying or powder coating.

Further advantages of the invention result from the context of the description and the exemplary embodiments.

The invention is explained in still greater detail below with reference to one exemplary embodiment.

The figures show the following:

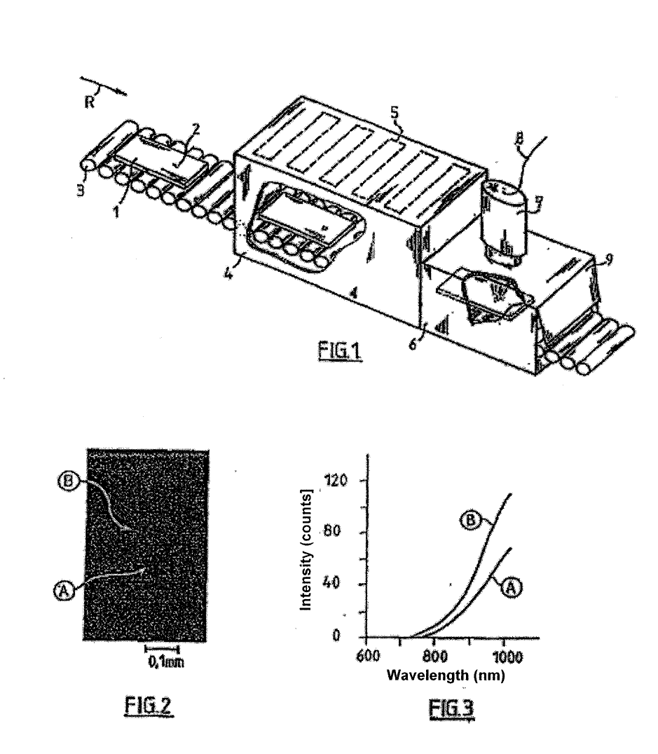

FIG. 1: a section of a device for tempering a tempered safety glass, with an integrated test device for detecting nickel sulfide inclusions;

FIG. 2: a photograph of a partial region of a tempered safety glass in a darkroom;

FIG. 3: sections from emission spectra determined at positions A and B according to FIG. 2.

FIG. 1 shows a section of a device according to the invention used in a continuous tempering or hardening of tempered safety glass. The device has a conveying means 3 by means of which a tempered safety glass 1 containing production-related nickel sulfide inclusions 2 is transported in the direction R to a continuous furnace 4 and is guided through same. The conveying means can have any desired design, such as a conveyor belt or consecutive rotatable rollers, provided that transport to and through the continuous furnace 4 is made possible. The continuous furnace 4 is provided with at least one heating element 5 by which a desired temperature, for example 650° C., may be set at a constant level in the continuous furnace 4. During transport through the continuous furnace 4 a tempered safety glass 1 to be hardened is heated to a hardening temperature, so that by the time it leaves the continuous furnace 4 at the latest, the tempered safety glass 1 has been brought to a temperature necessary for tempering/hardening.

A darkroom 6 is connected to the continuous furnace 4, into which darkroom a tempered safety glass 1 is conveyed after leaving the continuous furnace 4, without a cooling below 500° C. taking place. Via means not specially shown, the darkroom 6 is protected on the one hand from penetration of light from the continuous furnace 4 and on the other hand from penetration of light from the outlet region 9 of the darkroom. In this manner, a tempered safety glass 1 having a hardening temperature of 500° C. or greater can be observed for emissions in a completely dark chamber.

Emitted radiation can be observed using any desired device with which photons or electromagnetic radiation can be recorded. For example, a CCD camera 7, a photo-camera, or a spectrometer can be used. To allow attachment of the observation device to the darkroom 5, the darkroom has an opening through which radiation emitted from the tempered safety glass 1 may exit.

As shown in FIG. 1, a link may be made by a CCD camera 7 being directly attached to a darkroom 6 and directly receiving light supplied from the interior of the darkroom 6. Alternatively, a link can also be made by use of one or more optical waveguides. In this case an observation device, for example a CCD camera 7, may be mounted at a distance from the darkroom 6, and emitted radiation or light exiting from the opening in a darkroom 6 is conducted via optical waveguides to the entry slit to a CCD camera 7.

If images are to be recorded for image processing evaluation, and spectrochemical analyses are also to be performed, a device according to the invention can also include a spectrophotometer in addition to a CCD or CMOS camera.

The data recorded with the aid of a CCD camera 7 are sent via a data line 8 to an evaluation unit, for example a computer, and evaluated preferably in an automated manner.

One example of an evaluation of this type is shown in greater detail in FIGS. 2 and 3. FIG. 2 shows a photograph of a region of a tempered safety glass 1, as is obtained in an observation in a darkroom at approximately 620° C. In most cases a dark or black image is obtained, at location A, for example, since at these temperatures glass emits only very little visible radiation. In contrast, at location B, which corresponds to a nickel sulfide inclusion in the tempered safety glass 1, a red image is obtained (illustrated as a gray region in FIG. 2).

The spectral curves in FIG. 3, obtained with an optical spectrometer, correspond to locations A or B in FIG. 2. These spectral curves show that at the long-wave end of the visible electromagnetic spectrum the emission from a nickel sulfide particle is significantly greater than a blank reading for the glass. This means that, even for very small particles as shown in FIG. 2, the size and location of nickel sulfide inclusions can be easily detected and determined.

For performing a spectrophotometric analysis, in principle it is sufficient to observe emissions from a tempered safety glass at one specified wavelength position, for example at 800 nm. It is also advantageous to record radiation emitted in the near infrared, for example at 1200 nm, since for this range on the one hand cost-effective silicon-based detectors are known, and on the other hand a quotient of (emission from nickel sulfide/emission from glass) is at a maximum. In other words, in an evaluation nickel sulfide inclusions are particularly clearly distinguished from a glass matrix.

If an evaluation, possibly automated, of emitted radiation indicates that an excessive number of or overly large nickel sulfide inclusions are present based on an inclusion depth, the tempered safety glass 1 is rejected or not used. In that case it is expedient to remove the tempered safety glass 1 from the conveying means 3 immediately after leaving a darkroom 6, and to subject only usable tempered safety glass to intense cooling by means of a cooling device downstream of the darkroom 6. For this purpose, the conveying means 3 may also have a branch point at which, depending on the results of a test, tempered safety glass is conveyed either to a cooling device or to a reject collection device. A measure of this type further contributes to high energy efficiency, since only usable tempered safety glass has to be cooled.

As shown in FIG. 1, a darkroom 6 can be connected directly to a continuous furnace 4, and a conveying means 3 for transporting a tempered safety glass 1 through both devices may be provided. This has the advantage that continuous tempering, including testing for the presence of nickel sulfide inclusions, may be performed. Alternatively, hardening furnaces and darkrooms can also be separated from one another and, for example, placed next to one another. In this case several panes of tempered safety glass may be simultaneously heated to hardening temperature, which may be advantageous for demand-oriented and energy-efficient manufacture.

1. Method for testing for the presence of nickel sulfide inclusions in an object made of glass, such as a tempered safety glass, during a tempering or hardening thereof, wherein the object is brought to a temperature of at least 500° C., and at this temperature electromagnetic radiation emitted from the object is recorded and evaluated, after which the object is intensely cooled in order to temper or harden it.

2. Method according to claim 1, wherein the object is brought to a temperature of at least 600° C., in particular 630 to 680° C.

3. Method according to claim 1, wherein emitted radiation in the wavelength range of 800 to 1200 nm is recorded and evaluated.

4. Method according to claim 1, wherein emitted radiation is recorded by means of a CCD camera or a CMOS camera.

5. Method according to claim 1, wherein an evaluation is performed by means of a computer.

6. Method according to claim 1, wherein the object while in motion is brought to a temperature of at least 500° C. in a continuous furnace, for example, and after the temperature is reached, the emitted radiation is recorded in regions of the object while the object continues to move.

7. Glass testing device for testing for the presence of nickel sulfide inclusions in an object made of glass, such as a tempered safety glass, comprising a darkroom for recording an object made of glass having a temperature of at least 500° C., and a device connected to the darkroom, by means of which device radiation emitted from the object at the referenced temperature can be recorded.

8. Glass testing device according to claim 7, wherein the darkroom can be cooled.

9. Glass testing device according to claim 7, wherein the device comprises a CCD camera or a CMOS camera.

10. Glass testing device according to claim 9, wherein the CCD camera or CMOS camera is connected to a computer.

11. Glass testing device according to claim 7, wherein the darkroom has an internal coating of black high-temperature paint.

12. Glass testing device according to claim 11, wherein the coating is produced by spraying or powder coating.
